(19) United States
(12) Patent Application Publication
(10) Pub. No.: US 2005/0241704 A1
(43) Pub. Date: Nov. 3, 2005

(54) Pressure regulation valve

(76) Inventor: Kai Borntrager, Ravensburg (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/508,495

(22) PCT Filed: Mar. 18, 2003
(86) PCT No.: PCT/EP03/02790

§ 371 Date: May 23, 2005

(30) Foreign Application Priority Data
Mar. 22, 2002 (DE) 102 12 806.5

(51) Int. Cl. F15B 13/044

(52) U.S. Cl. 137/625.65

(57) ABSTRACT

A pressure regulation valve, having one housing, one control element with control edges for opening and closing gaps, which is controlled by a proportional solenoid and can establish a regulator function and a stop function. The establishment of the stop function and the regulator function is achieved by the feedback of a regulatory pressure of a valve.

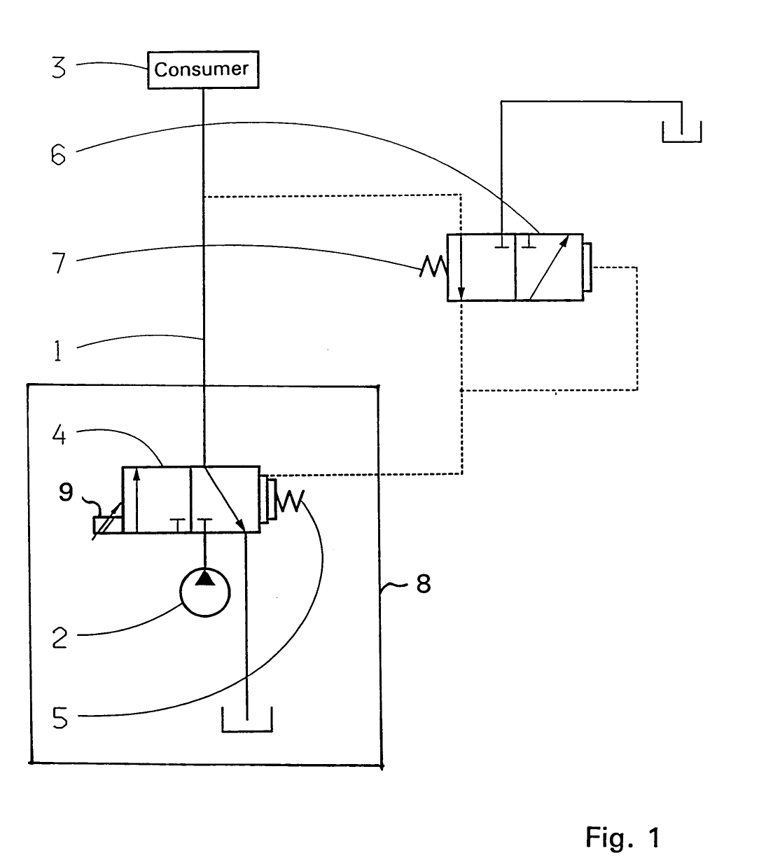

According to the kind specified in the preamble of claim 1, the invention concerns a pressure regulation valve.

Pressure regulation valves are widely known from the prior art; they are used, for example, as direct control valves for the control of clutches in automatic transmissions of motor vehicles. By way of these pressure regulation valves, pressure of up to 10 bars must be regulated during the shifting operations. But in automatic transmissions pressure of up to 24 bars are required, for example, for the stop positions in shifting elements. The pressure regulation valves must be designed for the maximum pressure occurring. This results in an impairment of the pressure resolution which leads to possible inaccurate regulation. Besides, the whole system is designed for the maximum pressure which results in that subsequent changes in the requirements of pressure regulation valves can be only carried out with difficulties.

In DE 199 04 902, A1, a pressure regulation valve is described, which is designed so that in a stop position of the armature, the smallest axial distance between the front ends facing each other of the armature and of the magnetic core is dimensioned so that the magnetic force between the armature and the magnetic core is stronger in this stop position than the magnetic force in the working range of the proportional solenoids and that the armature can be established in this stop position by the excessive magnetic force. The pressure regulation valve described in DE 199 04 902 A1, at the same time, makes use of the property that, in its working range, a proportional solenoid has a nearly horizontal power stroke characteristic line and the magnetic force in a range below a certain stroke, that is a distance between armature and magnetic core, suddenly increases compared to the magnetic force in the working range. By virtue of the magnetic characteristic with stronger magnetic forces accompanied by small air gaps it is possible, by adequate magnet design, to adjust a coil current or a “snap current” in which the working range of the magnet is run over and the armature is held within the range of the high magnetic force. Due to the connection of the armature, via the armature rod with the control element, the stop force of the control element is also increased so that the latter admissibly remains in its stop position, even in case of outcropping hydraulic main pressure of about 24 bar, since the hydraulic force which, in one direction, acts upon the control element, is weaker than the magnetic force acting against it. To implement the smallest distance between the magnetic core and the armature, a spacer disc, made of a non-magnetic material, is situated between the magnetic core and the armature. By way of such a disc, which prevents “magnetic adhesion” of the armature to the magnetic core, an adjustability of the magnetic force becomes possible by a different design thickness of the disc. The magnetic coil is connected with an electric control device which, for presettable time periods, emits a current impulse to the magnetic coil for maintaining the stop position of the armature. It is thus ensured that the armature retains its stop position, relative to the magnetic core, and does not unintentionally “fall off” the stop position and that the control element admissibly remains in its stop position. The current impulse has an intensity corresponding to a snap current and stronger than the stop current of the magnetic coil. The valve is designed so that, in the case of an unintended drop, the shifting elements still remain closed, i.e., the regulatory pressure is maintained. To detach the armature from the stop position, the coil is loaded with an electric control signal which, for example, occurs as a reduction and subsequent acceleration of he control current in the magnetic coil. The detachment of the armature from the stop position can also occur by a pressure signal which results as an increase of the hydraulic main pressure to a value above the stop pressure; the stop pressure increase acting upon, for example, the pressure feedback, especially upon the front end of the piston bore.

The pressure regulation valve, described in DE 199 04 902 A1, works with a magnetic stop function, which results from scanning the armature current by diagnosis of the mutual induction due to the armature movement. The magnetic stop function overcomes the danger that, as a result of occurring pressure impulses or high main pressures, the armature can be forced out of its stop position whereby the pressure in the working lines drops to a low pressure level. This, in turn, can result in faulty operation of the clutches. The establishment of a path-dependent stop function, via the properties of the magnetic characteristic line, has the further disadvantage that due to soiling, the stop function is impaired or absolutely can no longer be established. One fact that also acts disadvantageously is that the pressure regulation valve has, in addition, a slide valve which, dependent on pressure, can change its position and, by abutting on a control edge, limits the pressure in the working line to the maximum regulator pressure with simultaneous increase in leakage.

The problem on which this invention is based is to describe a pressure regulation valve which makes an accurate pressure regulation possible by an increased resolution. In a completely connected state, the supply pressure also cannot become so high as to force the armature out of its stop position. To ensure a reliable function, a cutting through of the high supply pressure must be possible at any time with reduced leakage. Besides, the pressure regulation valve must stand out by sturdiness, stability of oscillation and a reduced number of parts.

The problem on which the invention is based is solved by a pressure regulation valve according to the preamble of the main claim and also having the characteristic features thereof.

The pressure regulation valve is designed so that a pressure regulation takes place only in the area where actually needed, that is, the pressure regulation valve has the function of a regulation valve only in the area of the pressures to be regulated. Above this actually regulation area, the feedback regulation pressure is limited by a valve to the maximum regulation pressure or its completely turned off. The pressure regulation valve now works as a shifting valve. It remains open independently of the abutting supply pressure and working pressure. The pressure regulation valve is reset by spring tension and the compressive force resulting from the feedback of regulation pressure. By combining the properties of a regulation valve and of a shifting valve to define the regulation area more finely, on one hand, which results in a better adjustability and, on the other hand, high supply pressures can be connected therethrough without a problem. If the current increases further beyond the regulation area, the regulation pressure is automatically adjusted to the maximum regulation pressure and held there by a pressure-limiting valve or by a pressure-reducing valve. An excess of magnetic force generates here which leads to an opening of the control edge of the supply pressure on the slide valve. The latter reaches a final position. The supply pressure abuts in full height on the working line. The supply pressure can thus be freely varied without this acting upon the position of the slide valve. Since the slide valve does not abut on the control edge, the leakage can be clearly reduced by this solution.

Advantageous and convenient developments of the invention are indicated in the sub-claims. But the invention is not limited to the combination of features of the claims; to the contrary other possible logical combinations of claims and individual features of the claims result for the expert from the stated problem.

The invention is explained in detail herebelow with reference to an embodiment shown in the FIGURE.

The single FIGURE shows a hydraulic spare shifting diagram of an inventive pressure regulation valve. The inventive pressure regulation valve has one working line 1 through which the pressure medium can be conveyed from a pump 2 to a consumer 3. A directional valve 4 can be shifted against the force of the spring 5. If the directional valve 4 is shifted, the pump 2 conveys pressure medium to the consumer 3. A regulation pressure is returned to the directional valve 4 via a pressure-reducing valve 6. If the regulation pressure is less than the maximum admissible regulation pressure, the directional valve 4 remains in its position. But, if the value of the maximum admissible regulation pressure is exceeded, the pressure-reducing valve 6 is switched back against the force of a spring 7 and the directional valve 4 by means of the spring 5.

Reference Numerals

1 working line
2 pump
3 consumer
4 directional valve
5 spring
6 pressure-reducing valve
7 spring

1-5. (canceled)

6. A pressure regulation valve having a housing, a control element with control edges for opening and closing gaps, the pressure regulation valve being controlled by a proportional solenoid and can establish a regulatory function as well as a stop function;
wherein the stop function and the regulator function of the pressure regulation valve are established by a pressure regulation feedback of one valve.

7. The pressure regulation valve according to claim 6, wherein the pressure regulation valve is returned from the stop function to the regulatory function by the force of a spring (5) and the pressure resulting from the feedback of the regulatory pressure.

8. The pressure regulation valve according to claim 6, wherein the feedback of the regulator pressure can be limited to a maximum regulatory pressure and maintained there by the one valve.

9. The pressure regulation valve according to claim 6, wherein the one valve is a pressure-reducing valve (6).

10. The pressure regulation valve according to claim 6, wherein the one valve is a pressure-limiting valve (6).

11. A pressure regulation valve having a housing and a control element for controlling flow of pressurized fluid through the pressure regulation valve from a pump (2) to a consumer device (3) of an automatic transmission, the pressure regulation valve having both a regulatory function and a stop function and being controlled by a proportional solenoid;
wherein the stop function and the regulator function of the pressure regulation valve are established by a pressure regulation feedback from an other valve (6) communicating with the pressure regulation.

12. The pressure regulation valve according to claim 11, wherein the pressure regulation valve is returned to the regulatory function, from the stop function, by a force from a spring (5) and the pressure regulation feedback from the other valve (6).

13. The pressure regulation valve according to claim 11, wherein the other valve limits and maintains the feedback of the regulator pressure to a maximum regulatory pressure.

14. The pressure regulation valve according to claim 11, wherein the other valve is a pressure-reducing valve (6).

15. The pressure regulation valve according to claim 11, wherein the other valve is a pressure-limiting valve (6).

16. A pressure regulation valve having a housing and a control element for controlling flow of pressurized fluid through the pressure regulation valve from a pump (2) to a consumer device (3) of an automatic transmission, the pressure regulation valve having both a regulatory function and a stop function and being controlled by a proportional solenoid;
wherein the stop function and the regulator function of the pressure regulation valve are established by a pressure regulation feedback from an other valve (6) communicating with the pressure regulation; and
a spring (5) biases the control element into the stop function against a force of the proportional solenoid.

17. The pressure regulation valve according to claim 16, wherein the pressure regulation valve is returned to the regulatory function, from the stop function, by a force from a spring (5) and the pressure regulation feedback from the other valve (6).

18. The pressure regulation valve according to claim 16, wherein the other valve limits and maintains the feedback of the regulator pressure to a maximum regulatory pressure.

19. The pressure regulation valve according to claim 16, wherein the other valve is a pressure-reducing valve (6).

20. The pressure regulation valve according to claim 16, wherein the other valve is a pressure-limiting valve (6).
